(19) United States
(12) Patent Application Publication
(10) Pub. No.: US 2026/0359911 A1
(43) Pub. Date: Nov. 12, 2026

(54) DOCUMENT-DRAFTING ASSISTANCE DEVICE AND PROGRAM

(71) Applicants: Kazufumi KIMURA, Osaka (JP); BINGO Intellectual Property Support, Inc., Saitama (JP)

(72) Inventors: Kazufumi KIMURA, Osaka (JP); Motoharu BINGO, Saitama-shi, Saitama (JP); Akitsugu WATANABE, Saitama-shi, Saitama (JP)

(21) Appl. No.: 19/124,089

(22) PCT Filed: May 8, 2024
(86) PCT No.: PCT/JP2024/017039

§ 371 Date: Apr. 24, 2025

(30) Foreign Application Priority Data
May 9, 2023 (JP) 2023-077274

(51) Int. Cl. G06Q 50/18; G06F 40/186; G06F 40/40; G06N 20/00

(52) U.S. Cl. CPC G06Q 50/184; G06F 40/186; G06F 40/40; G06N 20/00

(57) ABSTRACT

[Problem] To facilitate the creation of high-quality patent office submission documents by providing various types of support information that align with the user's intent.

[Solution] The document preparation support device 1 of the present invention includes a document database, in which accumulated document information on patents and utility models is stored in a unified data format normalized to be adapted for training language models for natural language processing, and a support information generation unit 115 that, based on the document database, generates support information for assisting in the preparation of patent office submission documents by utilizing a language model that has been trained and adjusted to specialize in such document preparation by combining one or more types of natural language processing in accordance with the content of a prompt.

### TECHNICAL FIELD

The present invention relates to a document preparation support device and a program.

### BACKGROUND ART

Regarding a technology that supports the preparation of patent office submission documents, which are documents submitted to the patent office, such as application documents for patents and utility models, Patent Literature 1 discloses a technology in which a predetermined word before modification and a word after modification are associated when a word in a first set of claims that has already been created is later modified by the document creator, the technology further stores this association, along with related information such as hypernyms or hyponyms of the word before modification, in a storage unit, additionally, the technology updates the related information by similarly associating and storing a predetermined word before modification and a word after modification when a word in a second set of claims that has already been created is later modified by the document creator, and based on the updated related information, the technology outputs relevant information concerning an input word when creating a third set of claims.

According to the technology of Patent Literature 1, in the preparation of application documents for patents or utility models, related information, such as hypemyms or hyponyms of the word before modification, is outputted as support information, thereby enabling the document creator to refer to the support information and to be supported in drafting the application documents using appropriate expressions.

### CITATION LIST

### Patent Literature

[Patent Literature 1] JP2021-086425A

### SUMMARY OF THE INVENTION

### Problems to be Solved by the Invention

However, as the technology of Patent Literature 1 is a technology that utilizes information generated on the basis of related information associating a word before modification and a word after modification as support information, the support information is restricted to a scope based on the relevance between the words before and after modification. As a result, the application documents are prepared with reference to restricted support information, so there remains room for further improvement in terms of easily preparing high-quality application documents.

The present invention has been made in view of these circumstances, and its objective is to enable the easy preparation of high-quality patent office submission documents by providing various types of support information that conform to the user's intent.

### Means for Solving the Problems

As a result of intensive studies to solve the problems above, the inventors of the present invention have found that the aforementioned objective can be achieved by generating support information for assisting in the preparation of patent office submission documents by utilizing a language model that has been trained and adjusted to specialize in the preparation of patent office submission documents, in accordance with the content of a prompt. Thus, the inventors of the present invention have completed the present invention. Specifically, the present invention provides the following:

The present invention is a document preparation support device characterized in that it comprises a document database in which accumulated document information on patents and utility models is stored in a unified data format normalized so as to be adapted for training language models for natural language processing, and a support information generation unit that generates support information for assisting in the preparation of patent office submission documents by utilizing a language model that has been trained and adjusted to specialize in the preparation of patent office submission documents by combining one or more types of natural language processing, in accordance with the content of a prompt, based on the document database.

According to the features of the present invention, by utilizing a language model specialized for the preparation of patent office submission documents for patents and utility models in natural language processing, and by generating support information in accordance with the content of a prompt, various types of support information that conform to the intent of the user who inputs the content of the prompt are provided, thereby enabling the easy preparation of high-quality patent office submission documents.

### Effect of the Invention

According to the present invention, by providing various types of support information conforming to the intent of the user, high-quality patent office submission documents can be easily prepared.

### BRIEF DESCRIPTION OF DRAWINGS

FIG. 1 is an explanatory diagram showing the information flow of the document preparation support device according to the present embodiment.

FIG. 2 is a block diagram showing an example of the hardware configuration and software configuration of the document preparation support device according to the present embodiment.

FIG. 3 is an explanatory diagram of the display screen showing the user interface.

FIG. 4 is an explanatory diagram of the display screen showing the user interface.

FIG. 5 is an explanatory diagram of the display screen showing the user interface.

FIG. 6 is an explanatory diagram of the display screen showing the user interface.

### MODES FOR CARRYING OUT THE INVENTION

The following is a detailed description of an embodiment that exemplifies the present invention with reference to the drawings.

### Document Preparation Support Device 1

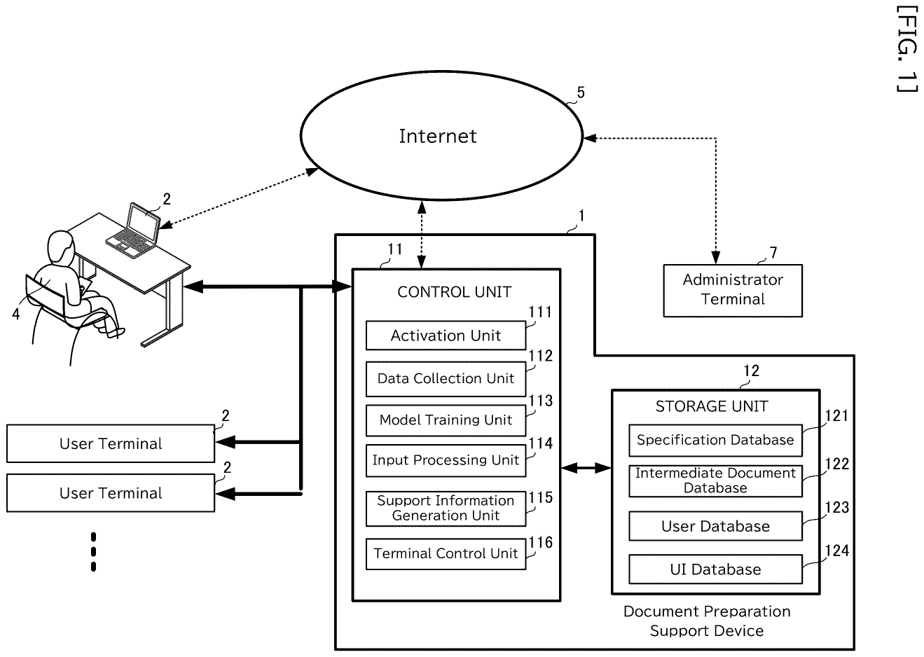

As shown in FIG. 1, document preparation support device 1 is configured to generate support information for assisting in the preparation of patent office submission documents by utilizing a language model specialized for natural language processing in the preparation of patent office submission documents for patents and utility models.

As a specific example, document preparation support device 1 includes a document database in which accumulated document information of patents and utility models is stored in a unified data format normalized so as to be adapted for training language models for natural language processing, and a support information generation unit 115 that generates support information for assisting in the preparation of patent office submission documents by utilizing a language model that has been trained and adjusted to specialize in the preparation of patent office submission documents for patents and utility models by combining one or more types of natural language processing, in accordance with the content of a prompt, based on the document database.

Here, “accumulated document information on patents and utility models” includes domestic documents such as published patent gazettes, published utility model gazettes, and registered gazettes (patent publication gazettes (patent gazettes), registered utility model gazettes), foreign documents such as U.S. patent specifications and international published gazettes, and non-patent documents such as domestic technical journals and conference proceedings. Furthermore, “accumulated document information” also includes documents such as opinions and amendment documents, various examination decision documents (examination-related trials, inter-party trials), opposition decision documents, and court decision gazettes. This accumulated document information is collected from various search sites, such as J-PlatPat® (a patent information search site), Espacenet® (a patent information search site provided by the European Patent Office), and WIPO PatentScope (an international patent information search site), as well as from case law search sites of the Intellectual Property High Court and data within various patent firms.

“Natural language processing” is for enabling a computer to understand written text and voice data in a natural language and to execute processing according to the intended purpose. Specifically, it includes morphological analysis, which decomposes natural language into the smallest unit, “morphemes,” and assigns information, such as word class; syntactic analysis, which clarifies the structure and meaning of a sentence by analyzing the grammatical structure of natural language; semantic analysis, which understands the meaning of words and sentences and performs logical judgments and reasoning; contextual analysis, which understands natural language while considering the preceding and following context of a sentence; and intent analysis, which extracts the intent of the speaker or writer from conversations or texts using natural language. Through this, “natural language processing” processes natural language by combining processes such as morphological analysis, syntactic analysis, semantic analysis, contextual analysis, and intent analysis, thereby enabling the generation of support information for assisting in the preparation of patent office submission documents in the present embodiment, as well as machine translation, automatic summarization, question-answering systems, and speech recognition.

“A language model” is a type of probabilistic model used in natural language processing and is a model that probabilistically predicts how likely given words or sentences are to occur as a natural language. Specifically, a language model calculates the occurrence probability of a given sequence of words or sentences and, by comparing the occurrence probabilities of multiple word sequences or sentences, enables the automatic generation of the most probable words or sentences when predicting the next word or sentence based on the context.

“A state normalized into a unified data format” means converting and systematically organizing information stored in different formats for each document into a common format when handling vast amounts of data, such as patent documents. For example, patent documents include various types of information, such as the names of applicants and inventors, application numbers and publication numbers, technical fields, document summaries, and claims; however, this information is often stored in different formats depending on the country, document type, or database. As a result, collecting the necessary information from multiple databases or handling information in different formats for the creation of a language model for natural language processing may become difficult, but normalizing data into a unified format makes data searching and analysis easier. Furthermore, when performing machine learning on accumulated document information, using normalized data as input enables improvements in processing efficiency and accuracy. It should be noted that “normalization” is a data processing method that structures and organizes data in database tables according to predefined rules to eliminate data redundancy and maintain data consistency and integrity.

The “document database” stores accumulated document information on patents and utility models in a state normalized into a unified data format so as to be adapted for training language models for natural language processing. As specific examples, a specification database 121, which stores specification information on patents and utility models, and an intermediate document database 122, which stores intermediate document information, such as opinions and amendment documents related to patents and utility models, correspond to the document database. As a result, even when specifications with different writing formats, such as those from Japan and the U.S., are collected as accumulated document information, specification data normalized into divisions such as “Problem to be Solved” and “Embodiments” are stored in each table of the specification database 121, thereby reducing data redundancy and enhancing data consistency. Furthermore, by linking the tables of the specification database 121, necessary information can be efficiently retrieved.

The “patent office submission documents for patents and utility models” refer to documents submitted to the patent office, and examples include specifications, amendment documents, opinions, trial request documents, and patent opposition statements for patents and utility models. The “language model” refers to a mathematical model in the field of natural language processing that learns language patterns and grammatical rules to generate and understand natural language. For example, a language model used in the preparation of patent office submission documents is trained specifically for the preparation of such documents and is used to generate specifications or opinions, which are types of patent office submission documents, in accordance with the content of a prompt, and to generate support information for preparing specifications and opinions.

In “training and tuning of the language model,” “training” includes supervised learning (e.g., tasks for predicting the next word) or unsupervised learning (e.g., tasks for learning the vector representations of words). Additionally, “tuning” refers to evaluating a trained language model and improving its performance by adjusting parameters such as the model's weights as necessary, or by appropriately adjusting hyperparameters such as the number of hidden layers and units in the neural network, the learning rate, and the strength of regularization.

A “prompt” is information that displays content to be inputted or operation methods for user 4 and provides instructions for the user 4 to perform operations. “Support information for assisting in the preparation of patent office submission documents” includes examples such as suggestions for appropriate terms and expressions when entering required information in documents, proposed corrections on grammar and expressions in sentences, provision of information that is useful for document preparation by referring to similar patent literature, and information or suggestions regarding the format and layout of documents. These prompts and support information will be described in detail later in the user interface section.

According to the configuration above, by utilizing a language model specialized for natural language processing in the preparation of patent office submission documents for patents and utility models, and by generating support information in accordance with the content of a prompt, various types of support information that conform to the intent of the user 4, who inputs the content of the prompt, are provided, thereby enabling the easy preparation of high-quality patent office submission documents.

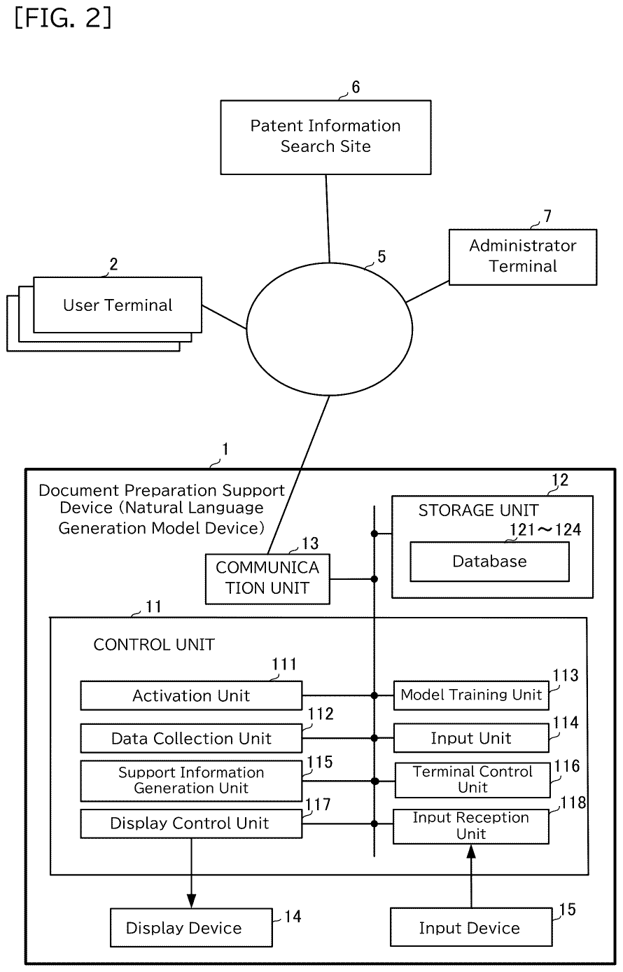

Furthermore, as shown in FIG. 2, the document preparation support device 1 includes, in addition to the support information generation unit 115, an activation unit 111, a data collection unit 112, a model training unit 113, an input processing unit 114, a terminal control unit 116, and a communication unit 13, Some or all of the support information generation unit 115, activation unit 111, data collection unit 112, model training unit 113, input processing unit 114, and terminal control unit 116 may be implemented in either hardware or software and are included in a control unit 11, which is a computer.

The communication unit 13 is connected to a user terminal 2 operated by the user 4 via the Internet 5, enabling data communication. It should be noted that the data communication between the communication unit 13 and the user terminal 2 is not limited to the Internet 5 and may utilize other information communication networks such as dedicated lines or a local area network (LAN), or a short-range wireless communication standard, such as Bluetooth® may be used. Additionally, to prevent the leakage of highly confidential patent office submission documents, the data communication between the communication unit 13 and the user terminal 2 may be conducted via a dedicated line. Furthermore, when the communication unit 13 and the user terminal 2 communicate via the Internet 5, it is preferable that they have a virtual private network (VPN) function. When the VPN function is incorporated into the communication unit 13 and the user terminal 2, data communication from the user terminal 2 is routed through a VPN connection, thereby protecting against unauthorized external access and ensuring secure communication. It should also be noted that the user terminal 2 is an information processing device, such as a general personal computer, laptop computer, smartphone, or tablet terminal.

The activation unit 111 has a function of enabling data communication only with authenticated user terminal 2. Specifically, the activation unit 111 has a function of verifying whether an activation signal transmitted from a specific user terminal 2 matches the preconfigured authentication information. As authentication methods, examples include authentication modes that combine one or more authentication factors, such as password authentication, biometric authentication, one-time password authentication, and smart card authentication using a card embedded with an IC chip. Through this, the document preparation support device 1 is capable of data communication only with authenticated user terminal 2, thereby making the leakage of highly confidential patent office submission documents more difficult.

The data collection unit 112 has a function of collecting the accumulated document information on patents and utility models from patent information search sites 6 and the like, normalizing the collected information into a unified data format, and storing it in the document database. Through this, the data collection unit 112 gathers and organizes the data necessary for training and tuning the language model and stores them in the document database, thereby enabling the support information generation unit 115 to efficiently and accurately assist in the preparation of patent office submission documents. It should be noted that the collection of accumulated document information may also be performed by the administrator of the document preparation support device 1, accessing patent information search sites 6 and the like by operating an administrator terminal 7.

The model training unit 113 has a function of training and tuning a language model for natural language processing based on the patent and utility model document database. Through this, the model training unit 113 trains and tunes the language model to specialize in the preparation of patent office submission documents, thereby performing more advanced natural language processing and enabling the support information generation unit 115 to generate high-quality support information for assisting in the preparation of patent office submission documents.

The input processing unit 114 has a function of converting prompt information, which indicates the content of a prompt transmitted from the user terminal 2, into information that is easier to handle for the language model used in natural language processing. The terminal control unit 116 has a function of configuring the display screen of the user terminal 2 to a screen suitable for the preparation of patent office submission documents based on data from the UI database 124 (user interface database 124). Details will be described later.

Furthermore, the document preparation support device 1 includes an input device 15 connected to an input reception unit 118 and a display device 14 connected to a display control unit 117. Examples of the input device 15 include a keyboard, a mouse, a touch panel, and a voice input device. Examples of the display device 14 include a liquid crystal display device. Through this, the document preparation support device 1 can be configured using an information processing device such as a general personal computer, a laptop computer, a smartphone, or a tablet terminal. It should be noted that the document preparation support device 1 may be configured without at least one of the input device 15 and the display device 14. In this case, as the input device 15 and the display device 14 are provided in an external terminal (not shown), the document preparation support device I can be used as a document preparation support server. Furthermore, the document preparation support device I may be used as the user terminal 2, and the user 4 may prepare patent office submission documents in the document preparation support device 1 while receiving support from the support information.

It should be noted that, in the present embodiment, the case where the functions of the document preparation support device 1 are installed in an information processing device is described, but the invention is not limited to this, and the functions of the document preparation support device 1 may also be installed in cloud computing. In this case, by adding computing resources as needed through cloud computing, a large volume of document data can be processed, enabling faster and more efficient processing, and even if the number of users 4 increases significantly, the processing capacity can be easily expanded to accommodate the demand.

### Storage Unit 12, and Related Components

As shown in FIG. 1, the specification database 121, the intermediate document database 122, which stores documents such as opinions and amendment documents associated with examinations, and the UI database 124 are stored in the storage unit 12. The storage unit 12 is connected to the document preparation support device 1 in a manner that enables data communication. The storage unit 12 may be configured with a hard disk or may be configured as a combination of a hard disk and memory. In the case of a configuration combining a hard disk and memory, a portion of the data used by the database, such as indexes, can be cached in memory as needed, thereby enabling faster access to the database. Additionally, the storage unit 12 also stores a user database 123, which retains various types of information, including identification information for specifying the user 4 and authentication information for authenticating the user 4. The activation unit 111 is configured to execute authentication processing and other operations based on the data in the user database 123.

It should be noted that the storage unit 12 may be a data server that is separate from the document preparation support device 1 and connected to an information communication network such as the Internet 5. Additionally, the storage unit 12 may be configured using multiple data servers provided for each database.

### (user Interface)

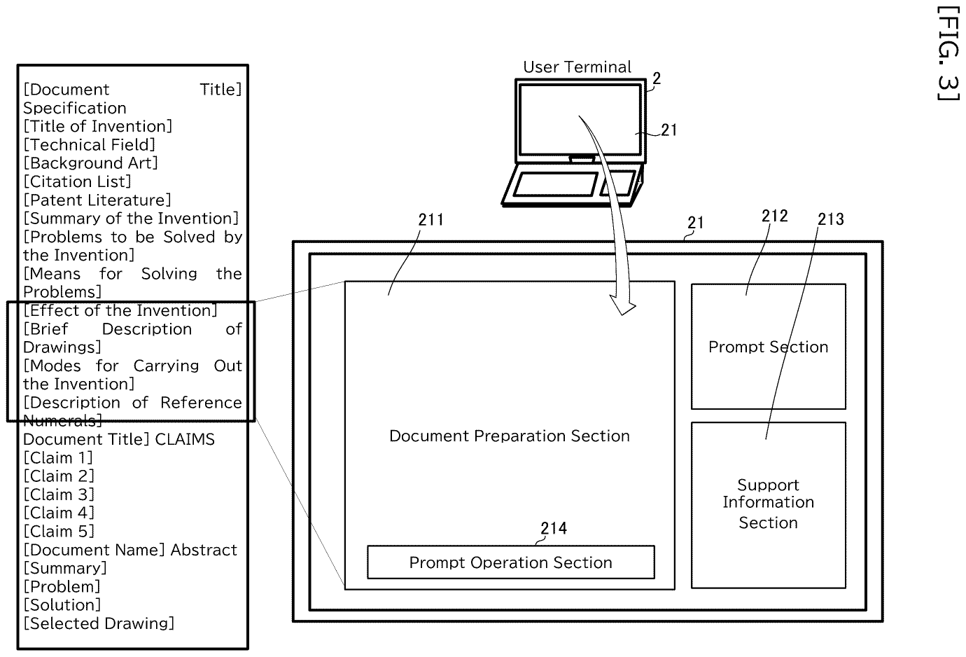

As shown in FIG. 3, the terminal control unit 116 has a function of configuring the display screen of the user terminal 2 into a screen suitable for the preparation of patent office submission documents based on the UI database 124. To describe a specific example, the terminal control unit 116 has a function of controlling the display screen 21 of the user terminal 2 so that it displays a prompt section 212, which receives the content of a prompt; a support information section 213, which displays the support information generated by the support information generation unit 115; and a document preparation section 211, which serves as the area for preparing patent office submission documents. Through this, the user 4, who is using the user terminal 2, can simultaneously check the content of the prompt section 212 and the support information in the support information section 213 while preparing the patent office submission documents, thereby enabling the preparation of the patent office submission documents to proceed more smoothly. It should be noted that at the start of a patent office submission document such as a specification, the user terminal 2 may display the entry fields in the document preparation section 211 in a format that complies with the prescribed regulations.

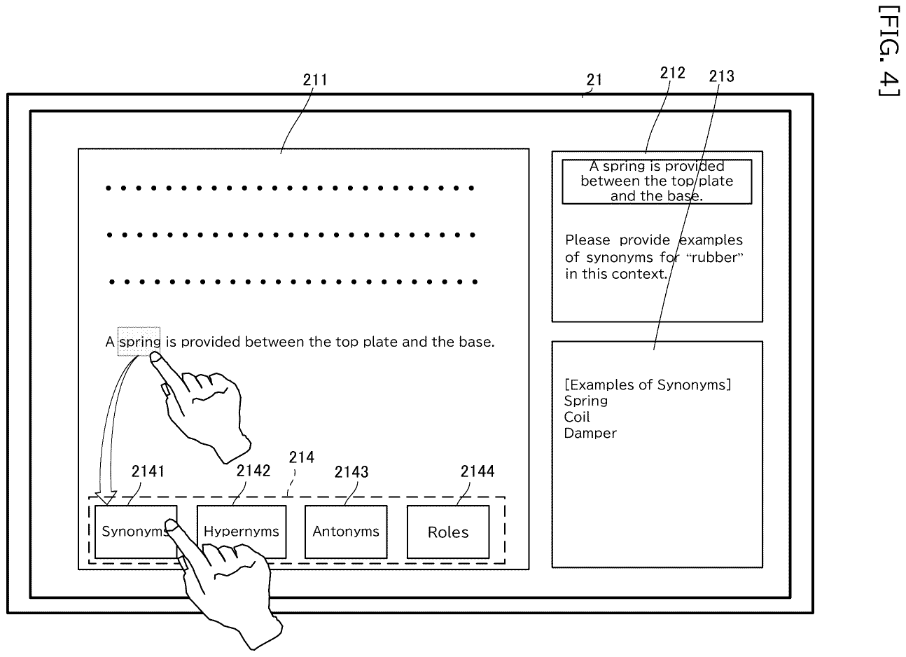

Furthermore, as shown in FIG. 4, the terminal control unit 116 has a function to allow the user to specify template sentences that indicate predetermined instruction contents, such as synonyms, antonyms, and roles, and to control the display screen 21 of the user terminal 2 so that a prompt operation section 214 is displayed. The prompt operation section 214 inputs content into the prompt section 212 by combining the specified template sentence with the word or phrase designated in the document preparation section 211.

As a specific example, when there are multiple instruction elements as the “predetermined instruction contents,” such as synonyms, hypernyms, antonyms, and roles, the template sentences including these instruction elements are converted into buttons, and a first instruction button 2141 for template sentences with synonyms as the instruction content, a second instruction button 2142 for template sentences with hypernyms as the instruction content, a third instruction button 2143 for template sentences with antonyms as the instruction content, and a fourth instruction button 2144 for template sentences with roles as the instruction content are displayed in the prompt operation section 214. For example, when the phrase “A spring is provided between the top plate and the base.” is written in the document preparation section 211, if the user 4 designates the word “spring” and drags it to the first instruction button 2141, or if the user 4 designates the word “spring” and clicks the first instruction button 2141, the word “spring” is stored in the memory of the user terminal 2 and is combined with the prompt data of the template sentence associated with the first instruction button 2141 that was previously stored in memory. The combined data are then displayed in the prompt section 212 of the user terminal 2.

Through this, in the prompt section 212, information that combines the word and the template sentence, such as “Please provide examples of synonyms for rubber.” is displayed as the content of the prompt. This prompt content is sent to the document preparation support device 1, and in the support information generation unit 115, “[Example of synonyms] Spring, coil, damper” is generated as support information. This support information is sent to the user terminal 2 and displayed in the support information section 213, allowing the user 4 to visually refer to or copy and paste the support information in the support information section 213 while continuing to draft the specification using examples of synonyms for spring. Through this, the user 4, who is using the user terminal 2, can input content into the prompt section 212 by combining the predetermined instruction content with the designated word or phrase, thereby facilitating the preparation of patent office submission documents.

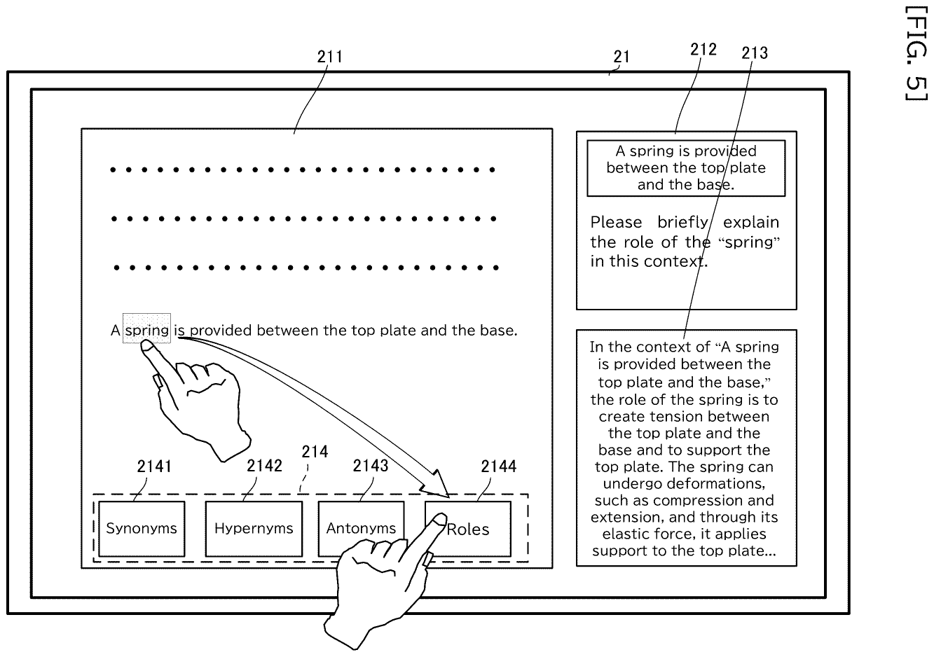

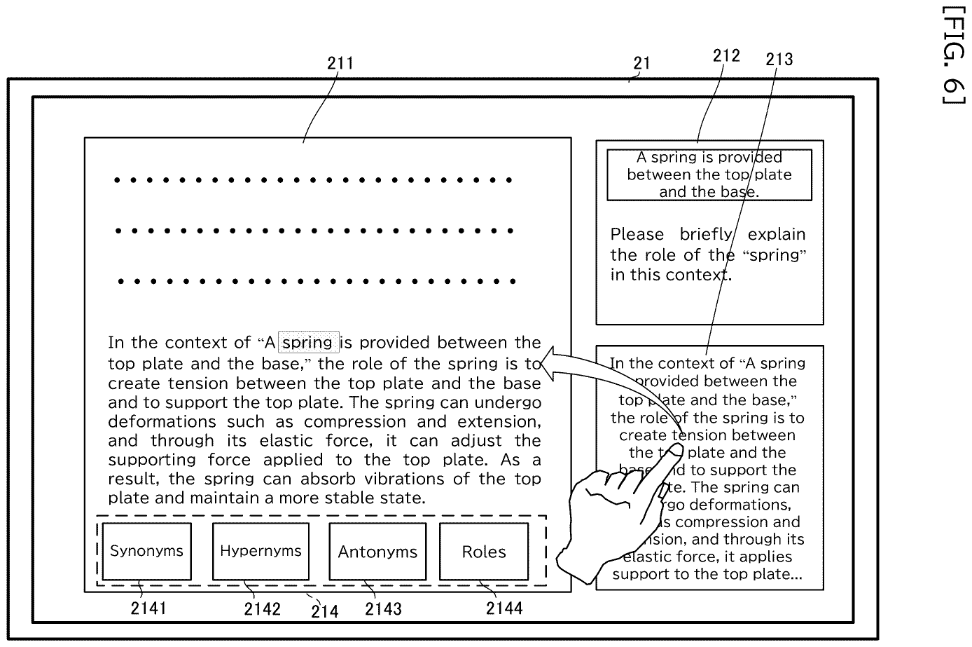

Furthermore, as shown in FIG. 5 and FIG. 6, the terminal control unit 116 has a function to allow the user to specify template sentences that indicate predetermined instruction contents and to control the display screen 21 so that a prompt operation section 214 is displayed. The prompt operation section 214 inputs content into the prompt section 212 by combining the specified template sentence with a phrase containing the designated word in the document preparation section 211.

As a specific example, when the phrase “A spring is provided between the top plate and the base.” is written in the document preparation section 211, if the user 4 designates the word “spring” and drags it to the fourth instruction button 2144, or if the user 4 designates the word “spring” and clicks the fourth instruction button 2144, the phrase containing the word “spring” is stored in the memory of the user terminal 2 and is combined with the prompt data of the template sentence associated with the fourth instruction button 2144 that was previously stored in memory. Then, the combined data is displayed in the prompt section 212 of the user terminal 2.

Through this, in the prompt section 212, the phrase “A spring is provided between the top plate and the base.” and the phrase “Please provide examples of synonyms for ‘rubber in this context.” are displayed as the content of the prompt. This prompt content is sent to the document preparation support device 1, and in the support information generation unit 115, support information is generated as follows: “In the context of 'A spring is provided between the top plate and the base,’ the role of the spring is to create tension between the top plate and the base and to support the top plate. The spring can undergo deformations such as compression and extension, and through its elastic force, it . . . ” This support information is sent to the user terminal 2 and displayed in the support information section 213, allowing the user 4 to visually refer to or copy and paste the support information in the support information section 213 while continuing to draft the specification regarding the role of the spring. Through this, during the preparation of patent office submission documents, information that combines the predetermined instruction content with the phrase containing the designated word is inputted as the content of the prompt section 212, whereby an appropriate response can be obtained from the context of the phrase, so that the preparation of patent office submission documents can be further facilitated.

Furthermore, the terminal control unit 116 may have a function to configure the user interface of the user terminal 2 according to the following configurations 1 to 6.

### Configuration 1

While composing a document in the document preparation section 211, the timing of completing a word, a phrase, or a paragraph is automatically detected, and at these timings, the text information of the word, phrase, or paragraph is transferred to the prompt section 212, where the document preparation support device I may then predict the subsequent text based on the transferred text information and display it as support information in the support information section 213. At this time, the corresponding portion in the document preparation section 211, which corresponds to the text information transferred to the prompt section 212, may be highlighted. In this case, the user 4 can easily determine which word, phrase, or paragraph the support information corresponds to. It should be noted that instead of automatically detecting the timing of completing a word, phrase, or paragraph, a fifth instruction button may be provided, and at the timing when the fifth instruction button is clicked, support information that predicts the subsequent text following the word, phrase, or paragraph may be displayed.

### Configuration 2

The document preparation section 211 may be provided with a sixth instruction button for requesting advice on preparing specifications for patents and utility models based on invention information, such as an inputted outline of the invention or invention-related materials. For example, when meeting materials are inputted and the sixth instruction button is clicked, the document preparation support device 1 extracts and summarizes key points from the materials and displays them as support information in the support information section 213. Additionally, when the sixth instruction button is clicked, a prompt such as “Read the following material 1 and tell me the points you think would be unknown to a person skilled in the art. (line break×2) (Material 1 body)” is displayed in the prompt section 212, and the support information section 213 displays key points that may indicate novelty as a bullet list with two-line breaks. Subsequently, when the sixth instruction button is clicked again, a prompt such as “Read the following material 1 and tell me the points you think would be well-known to a person skilled in the art. (line break×2) (Material 1 body)” is displayed in the prompt section 212, and the support information section 213 displays key points that may indicate inventive step as a bullet list with two-line breaks.

Furthermore, when the user 4 considers and inputs invention points based on the support information (key points) and then clicks the sixth instruction button again, the document preparation support device 1 extracts prior art documents from the specification database 121, identifies structural elements that may have novelty or inventive step and structural elements suspected of being well-known technologies, and displays these structural elements as support information. It should be noted that in Configuration 2, for the purpose of improving the operability for the user 4, the user interface is designed so that by continuously clicking the sixth instruction button, the novelty extraction process, the inventive step extraction process, and the structural element evaluation process are executed consecutively, but the invention is not limited to this, and separate instruction buttons may instead be provided for each evaluation process. Additionally, when the sixth instruction button is clicked, multiple types of prompt content indicating the novelty extraction process, the inventive step extraction process, and the structural element evaluation process may be displayed in the prompt section 212 in a selectable manner.

### Configuration 3

The document preparation section 211 may be provided with a seventh instruction button for creating claim drafts. For example, when invention points are inputted and the seventh instruction button is clicked, the document preparation support device 1 generates a claim draft based on the specification database 121 and displays it as support information. Furthermore, when a claim draft is inputted and the seventh instruction button is clicked, a draft of the overall structure of the specification may be displayed as support information. Specifically, when a claim draft is input and the seventh instruction button is clicked, the prompt section 212 displays “Please provide a draft of the overall structure of the specification corresponding to the following claims. (line break ×2) (CLAIMS)”, and the support information section 213 displays support information showing the draft of the overall structure of the specification. Additionally, when the seventh instruction button is clicked again, the prompt section 212 displays “Please provide examples of descriptions of the embodiments for the following structural elements. If there are sections in the materials that should be referenced, please indicate them as well. (line break ×2) (structural elements shown in the overall structure draft)”, and the support information section 213 displays examples of embodiment descriptions and reference sections in the materials.

Additionally, after the user terminal 2 has created a claim draft and the seventh instruction button is clicked, the prompt section 212 may display “Check whether the following claims include reference numerals. (line break×2) (CLAIMS)”, with the check result displayed in the support information section 213, or it may display “For each term in the following claims, provide candidate words that serve as hypernyms. (line break ×2) (CLAIMS)”, with the candidate words serving as hypemyms displayed in the support information section 213. It should be noted that instead of the seventh instruction button, separate instruction buttons may be provided according to the content of each prompt. Additionally, when the seventh instruction button is clicked, multiple types of prompt contents may be displayed in a selectable manner.

### Configuration 4

The document preparation section 211 may be provided with an eighth instruction button for checking the format and grammar of the specification, as well as inconsistencies in terminology and reference numerals. For example, when the eighth instruction button is clicked during the preparation of the specification or after its completion, the document preparation support device I performs a check on the format, grammar, and inconsistencies in terminology and reference numerals, and the results are displayed as support information. Furthermore, the proposed corrections for the various checked items may also be displayed as support information.

### Configuration 5

The document preparation section 211 may be provided with a ninth instruction button for checking whether an amendment proposal or opinion statement draft can resolve the grounds for rejection (e.g., whether opinions are provided for all grounds of rejection). Specifically, when the ninth instruction button is clicked, the prompt section 212 displays, “Summarize and memorize the following notice of reasons for rejection. (line break ×2) (notice of reasons for rejection),” and “Check whether the following opinion statement draft can resolve the grounds for rejection notified in the previously memorized notice of reasons for rejection. Also, provide a revised proposal. (line break ×2) (opinion statement draft),” and the check results and proposed revisions are displayed in the support information section 213.

### Configuration 6

The document preparation section 211 may be provided with a tenth instruction button for generating drawing drafts, such as flowcharts, block diagrams, or data table drafts corresponding to the content of the entered claims or part of the specification, or it may be provided with a tenth instruction button for generating claim drafts or specification drafts corresponding to the content of flowcharts, block diagrams, or data tables.

### Document Preparation Support Program

The activation unit 111, the data collection unit 112, the model training unit 113, the input processing unit 114, the support information generation unit 115, the terminal control unit 116, the display control unit 117, and the input reception unit 118 may each be configured with either hardware or software. Each of these units 111 to 118 constitutes at least part of the control unit 11. When these units 111 to 118 are implemented in software, a computer, which serves as the control unit 11, executes a document preparation support program that generates support information for assisting in the preparation of patent office submission documents by utilizing a language model specialized in natural language processing for the preparation of such documents.

As a specific example, the document preparation support program enables a user terminal 2, which is a terminal device capable of accessing the document preparation support device 1 that includes a document database in which accumulated document information on patents and utility models is stored in a unified data format normalized to be adapted for training language models for natural language processing, and a support information generation unit 115 that, based on the document database, generates support information for assisting in the preparation of patent office submission documents by utilizing a language model that has been trained and adjusted to specialize in such document preparation by combining one or more types of natural language processing, to execute a display processing step (S1) that displays on the user terminal 2 a prompt section 212 for receiving the content of a prompt, a support information section 213 for displaying the support information generated by the support information generation unit 115, a document preparation section 211 that serves as an area for preparing patent office submission documents, and a prompt operation section 214 that allows the user 4 to specify template sentences indicating predetermined instruction contents. With the program above, the user can simultaneously check the content of the prompt section and various types of support information in the support information section while preparing patent office submission documents.

The document preparation support program may also be configured to execute a prompt operation step (S2) on the computer of the user terminal 2, in which, when a word or phrase is designated in the document preparation section 211 and a template sentence is designated in the prompt operation section 214, the designated template sentence and the designated word or phrase in the document preparation section 211 are combined into information that is input as the content of the prompt section 212. With the program above, during the preparation of patent office submission documents, the content inputted into the prompt section 212 is information that combines the predetermined instruction content with the designated word or phrase, thereby facilitating the preparation of high-quality patent office submission documents.

Furthermore, the document preparation support program may also be configured to execute processing steps on the computer of the user terminal 2 that implement the various functions provided by the terminal control unit 116.

According to the document preparation support program configured as described above, the preparation of patent office submission documents by the user 4 can be supported with high accuracy in various ways, enabling the rapid and high-quality creation of patent office submission documents. Furthermore, by simply installing the program on an information processing device, such as a personal computer or a tablet terminal, the information processing device can function as the document preparation support device 1. It should be noted that the program may be distributed in a recorded state on a storage medium such as a CD-ROM or USB memory, or it may be distributed via a bidirectional communication network, such as the Internet, or a unidirectional communication network, such as television broadcasting.

### Document Preparation Support Method

Some or all of the steps in the document preparation support program may be implemented in hardware. That is, as long as the user terminal 2, which can access the document preparation support device 1, is configured to execute the document preparation support method, it is sufficient. Specifically, the document preparation support method is executed on the user terminal 2, which is capable of accessing the document preparation support device 1 that includes a document database in which accumulated document information on patents and utility models is stored in a unified data format normalized to be adapted for training language models for natural language processing, and a support information generation unit 115 that, based on the document database, generates support information for assisting in the preparation of patent office submission documents by utilizing a language model that has been trained and adjusted to specialize in such document preparation by combining one or more types of natural language processing, and includes a display processing step (SI). Furthermore, the document preparation support method may also include a prompt operation step (S2) and processing steps that implement the various functions provided by the terminal control unit 116.

In the description above, an explanation was provided using the document preparation support device 1, which generates support information by utilizing a language model specialized in natural language processing for the preparation of patent office submission documents; however, the invention is not limited to this. That is, the terminal control unit 116, which configures the user interface, may be provided in a document preparation support device that generates support information using a general-purpose language model for natural language processing, such as ChatGPT, or the document preparation support program and the document preparation support method may be applied to a user terminal 2 that is capable of accessing such a document preparation support device.

Specifically, the terminal control unit 116, which configures the user interface of the user terminal 2, may be provided in a document preparation support device that is capable of data communication via the Internet 5 with information sources such as websites and databases and that generates support information by utilizing a general-purpose language model for natural language processing in accordance with the content of a prompt. Additionally, the document preparation support program may be a program that executes various processing steps of the present embodiment on a computer of a user terminal 2 that is capable of data communication with a document preparation support device that generates support information using a general-purpose language model for natural language processing. Furthermore, the document preparation support method may be a method executed on a user terminal 2 that is capable of data communication with a document preparation support device that generates support information using a general-purpose language model for natural language processing.

It should be understood that those skilled in the art can conceive of various modifications and alterations within the scope of the inventive concept. Therefore, these modifications and alterations are considered to fall within the scope of the present invention. For example, additions, deletions, or design changes of components, or additions, omissions, or changes of conditions of processes made by a person skilled in the art to the aforementioned embodiments, as appropriate, are also included in the scope of the invention, as long as they provide the gist of the invention.

### DESCRIPTION OF REFERENCE NUMERALS

1 Document Preparation Support Device
11 Control Unit
111 Activation Unit
112 Data Collection Unit
113 Model Training Unit
114 Input Processing Unit
115 Support Information Generation Unit
116 Terminal Control Unit
117 Display Control Unit
118 Input Reception Unit
12 Storage Unit
121 Specification Database
122 Intermediate Document Database
123 User Database
124 UI Database
13 Communication Unit
14 Display Device
15 Input Device
2 User Terminal
21 Display Screen
211 Document Preparation Section
212 Prompt Section
213 Support Information Section
214 Prompt Operation Section
4 User
5 Internet
6 Patent Information Search Site
7 Administrator Terminal

1. A document preparation support device, comprising:
a specification database storing specification information on patents and utility models, and an intermediate document database storing intermediate document information such as opinions and amendment documents related to patents and utility models, as a document database, in which published patent gazettes, published utility model gazettes, and registered gazettes (patent publication gazettes (patent gazettes), registered utility model gazettes) as domestic documents, U.S. patent specifications and international published gazettes as foreign documents, non-patent documents such as domestic technical journals and conference proceedings, opinions and amendment documents, various examination decision documents (examination-related trials, inter-party trials), opposition decision documents, and court decision gazettes as accumulated document information of patents and utility models, are stored in a unified data format normalized so as to be adapted for training language models for natural language processing; and
a support information generation unit that, by utilizing a language model according to the content of a prompt, generates support information for assisting in the preparation of patent office submission documents for patents and utility models, including specifications, amendment documents, opinions, trial request documents, and patent opposition statements;
wherein the language model is trained and adjusted to specialize in the preparation of the patent office submission documents by combining one or more types of processing in natural language processing, including morphological analysis, syntactic analysis, semantic analysis. contextual analysis, and intent analysis, based on the accumulated document information of the specification database and the intermediate document database serving as the document database, to probabilistically predict how the words and sentences provided in the prompt are likely to appear in natural language, and to generate the support information for preparing the patent office submission documents through the prompt; and
wherein the support information generation unit analyzes the content of the prompt using the language model and, based on the analyzed content of the prompt, predicts and generates the support information using the language model.

2. The document preparation support device according to claim 1, further comprising a terminal control unit that controls the display on a user terminal of a prompt unit for receiving the content of the prompt, a support information unit for displaying the support information generated by the support information generation unit, and a document preparation unit as a preparation area for the patent office submission documents.

3. The document preparation support device according to claim 2, wherein the terminal control unit allows a user to specify a predetermined template text indicating prescribed instruction content and controls the user terminal to display a prompt operation unit that sets as the content input to the prompt unit information combining the specified template text with a phrase specified in the document preparation unit.

4. The document preparation support device according to claim 2, wherein the terminal control unit allows a user to specify a predetermined template text indicating prescribed instruction content and controls the user terminal to display a prompt operation unit that sets as the content input to the prompt unit information combining the specified template text with a clause containing a phrase specified in the document preparation unit.

5. (canceled)

6. A program for execution on a computer of a terminal device that has access to a document preparation support device comprising:
a specification database, which stores accumulated information on patents and utility models, including domestic documents such as published patent gazettes, published utility model gazettes, and registered gazettes (patent publication gazettes and registered utility model gazettes), foreign documents such as U.S. patent specifications and international publication gazettes, non-patent literature such as domestic technical journals and proceedings, and various examination-related documents such as written opinions, amendment documents, trial decision documents (examination trials, inter-party trials), opposition decision documents, and judgment gazettes, in a state normalized into a unified data format so as to be adapted for training a language model for natural language processing, as a document database comprising a specification database storing specification information of patents and utility models and an intermediate document database storing intermediate document information, including written opinions and amendment document information; and
a support information generation unit that, based on the document database, utilizes a language model, by combining one or more types of natural language processing, in accordance with the content of a prompt, generates support information to assist in preparing patent office submission documents for patents and utility models, including specifications, amendment documents, written opinions, trial petitions, and patent opposition statements, wherein the language model, based on the accumulated document information of the specification database and the intermediate document database, both serving as the document database, combines one or more types of natural language processing, including morphological analysis, syntactic analysis, semantic analysis, contextual analysis, and intent analysis, to probabilistically predict how words and sentences provided in a prompt are likely to appear in natural language, and is trained and adjusted to generate, through the prompt, support information for assisting in the preparation of patent office submission documents, thereby being specialized in the preparation of such patent office submission documents; and
wherein the support information generation unit analyzes the content of the prompt using the language model and, based on the analyzed content of the prompt, predicts and generates the support information using the language, wherein the program causes the computer of the terminal device to execute:
a display processing step that controls the display on the terminal device of a prompt unit for receiving the content of the prompt, a support information unit for displaying the support information generated by the support information generation unit, a document preparation unit as a preparation area for the patent office submission documents, and a prompt operation unit that allows a user to specify a predetermined template text indicating prescribed instruction content; and
a prompt operation step that, when a phrase is specified in the document preparation unit and the template text is specified in the prompt operation unit, sets as the content input to the prompt unit information combining the specified template text with the phrase specified in the document preparation unit.
